(19) United States
(12) Patent Application Publication
(10) Pub. No.: US 2004/0132848 A1
(43) Pub. Date: Jul. 8, 2004

(54) High strength foam tool and method

(76) Inventors: LeRoy L. Whinnery JR., Danville, CA (US); Steven H. Goods, Livermore, CA (US); Craig C. Henderson, Livermore, CA (US); Thomas E. Bennett, Livermore, CA (US)

Correspondence Address: Timothy Evans, MS 9031, Sandia National Laboratories, 7011 East Avenue, Livermore, CA, 94550, US

(21) Appl. No.: 10/652,647

(22) Filed: Aug. 28, 2003

(51) Int. Cl. B29C 44/02; C08G 18/00

(52) U.S. Cl. 521/155; 264/55

(57) ABSTRACT

Disclosed is a closed-cell polyisocyanurate foam composition capable of high compressive strength at temperatures up to 200° C. The new composition further exhibits no loss or degradation in conventional mechanical properties—less than that which impacts the intended use. The formulation of the present invention is based on the reaction product of a isocyanate and an epoxide resin catalyzed by a mixture of a tertiary amine and a cyclic amine. Compressive strength is augmented by incorporating a large fraction of a non-reactive bulk filler into the precursor polymer gel.

### STATEMENT OF GOVERNMENT INTEREST

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing in this invention to license others on reasonable terms.

### BACKGROUND OF THE INVENTION

1. Field of the Invention

This invention generally relates to development of tooling for composite manufacture and as tooling for injection molding and hot embossing of polymers. In particular, the invention relates to methods for providing improved prototyping tools for construction of composite manufacturing and as tooling for injection molding and hot embossing of polymers. More particularly, the present invention relates to a syntactic foam composition for providing robust, reusable tooling.

2. Prior Art

As greater emphasis is placed on design and manufacture of complex light-weight composite structures, methods for quickly and inexpensively prototyping those structures have been sought. One method is the use of wax molds to prepare a casing having the shape or surface features that a manufacturer desires to render in a composite structure. In particular, Shape Deposition Manufacturing (SDM) technology comprises fabrication of parts by the sequential deposition, solidification, and precision CNC machining of wax layers, which are deposited upon one another until a desired product mold results (see for example, U.S. Pat. Nos. 6,508,971; 6,342,541; 6,259,962; and 5,301,415). A liquid resin (i.e., polyurethane, epoxy, or ceramic gel-casting slurry) can then be cast into the wax or plastic mold and cured to produce the desired part.

Unfortunately, many of the materials currently used to replicate the molds tend either to be fragile or difficult to use. The problematic nature of these materials make it difficult to prepare and produce usable lay-up tools. Moreover, many materials will not survive the elevated temperatures necessary to cure the resins used in traditional composite manufacturing. To a large extent the selection of the best choice of materials is determined by the nature of the molding technique, the environment to which the mold will be subjected, and an evaluation of the cost of materials, which have acceptable characteristics.

The present invention, therefore, is directed to the suitability of a category of materials referred to as syntactic foams. In particular, embodiments of the invention comprising specifically modified syntactic foam-filled materials, have been found to be highly suitable for preparing mold prototypes, particularly those which are, or which are likely to be, subjected to relatively high temperatures during processing.

### SUMMARY OF THE INVENTION

An embodiment of the present invention, therefore, relates to a robust, high strength polymer foam that is stable at elevated temperatures and capable of routine assembly and handling without significant damage or breakage.

More particularly, it is an object of this invention to provide polymer foams comprising a glass microsphere “filled” syntactic foam created by the reaction between an epoxy resin and isocyanate and an amine catalyst.

Another object of these embodiments is to provide a moldable polymer foam member capable of sustaining process temperatures above 177° C. (350° F.).

Yet another object of these embodiments is to provide a moldable polymer foam member capable of being prepared in thickness in excess of about 50 millimeters (2 inches).

Still other objects and advantages of the present invention will be ascertained from a reading of the following detailed description and the appended claims.

### BRIEF DESCRIPTION OF THE DRAWINGS

FIG. 1 illustrates the formation of an oxizolidinone by combining an isocyanate and an epoxide.

FIG. 2 illustrates the formation of a cyclic isocyanurate by a trimerization reaction of an isocyanate.

FIG. 3 illustrates the effect on the density of TEPIC foam that results from the addition of small amounts of water to the precursor constituent mixture.

FIG. 4 shows a photographic picture of a cutaway of a molded block of TEPIC foam illustrating the interior conformation of this material.

FIG. 5 shows an SEM image of a fracture surface of the TEPIC foam.

FIG. 6A shows a block of TEPIC in the process of being machined with a fly cut tool on a milling machine.

FIG. 6B shows a hollow cylinder of TEPIC and a part machined from a similar cylindrical part.

FIG. 7 illustrates the thermal expansion of the TEPIC polymer foam as it is heated from room temperature to about 200° C. with the slope being the coefficient of thermal expansion (CTE).

FIG. 8 illustrates the quasi-static uniaxial compression data for the standard TEPIC formulation with a density of 0.63 g/cm³.

FIG. 9 illustrates a method for molding a hollow TEPIC part.

### DETAILED DESCRIPTION OF THE INVENTION

Composites are traditionally cured at two temperatures: 120° C. and 175° C. (250° F. and 350° F.). Specialized materials are needed to provide tooling for composite structure. The tooling must act as both a support and replicating surface for these structures. At the same time, they must remain dimensionally stable at elevated temperatures during the resin cure process for the composite materials. A moldable fibrous material having the trade name Aquacore® made by the Advanced Ceramics Research Company (Tucson, Ariz.) and a machinable polyurethane stock product having the trade name Polyboard® made by Ciba Specialty Chemicals, Inc., (Basel, Switzerland), are examples of two materials in current use. Both of these materials, however, exhibit some characteristics that limit their usefulness as effective materials for providing composite lay-up tooling. In particular, when used with a wax mold, Aquacore® requires many hours or days (depending on the part thickness) to dry since it cannot be heated above the wax stump temperature. Furthermore, this material tends to crack during drying and the end material has been found to be brittle, weak and friable. Alternately, Polyboard® must be machined to shape and because it is most commonly produced as a 2″ thick stock sheet, lay-up tool shapes requiring thicker cross sections necessitate gluing multiple boards together. Unfortunately, due to the heating cycle through which the composite materials must be subjected, the “joined” Polyboard sections often debond during processing.

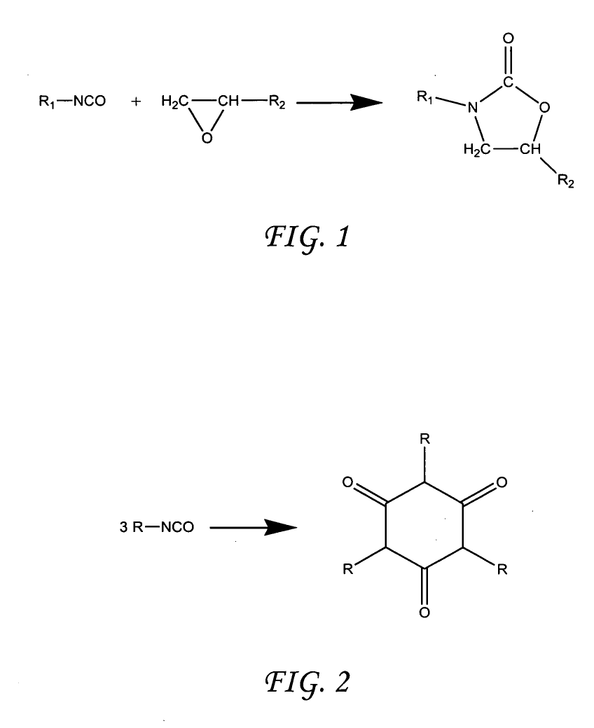

A structure resembling a traditional rigid polyurethane foam is desired since a continuous resin phase is known to have superior mechanical properties and machineability characteristics. To achieve this result, an approach that combines chemistries known to form thermally stable products is considered. The principal constituents are an oxizolidinone produced by the reaction of an isocyanate with an epoxide (FIG. 1), and a cyclic isocyanurate formed by the trimerization of an isocyanate (FIG. 2).

As these constituents are mixed some air is mechanically incorporated into the liquid. Additionally, a light-weight, non-reactive bulk filler is added to increase the modulus and reduce the density of the of the subsequently expanded polymer body. Optionally, a small amount of water also may be directly added to the mixture in order to further reduce the density of the polymer in those cases that require a lower density (for example, in applications where weight or thermal conductively is important). Furthermore, water may be introduced indirectly as water absorbed to the surface of the filler additive.

The high temperature structural foam produced by these materials is referred to hereinafter as “TEPIC,” an acronym for “The Epoxy PolyIsoCyanurate” polymer foam. The reactants used in processing TEPIC are listed in Table 1. The specific quantities listed yield a free rise density of about 0.4 g/cm³. These chemicals were used as supplied without further purification.

TABLE 1
CHEMICALS, AMOUNTS, AND MANUFACTURERS
USED IN PREPARATION OF TEPIC FOAMS.

| | Amount | |
|---|---|---|
| Chemical | (g) | Chemical Producer/Supplier |
| EPON ® 826 Epoxy Resin* | 129.6 | Resolution Performance |
| | | Products |
| PAPI ® 94 Isocyanate Resin | 243.0 | Dow Chemical |
| DABCO ® DC193 Surfactant | 16.2 | Air Products |
| SCOTCHLITE ® D32/4500 GMB | 60.0 | 3M |
| DABCO ® TMR-30 Catalyst | 0.9 | Air Products |
| POLYCAT ® 8 Catalyst | 0.3 | Air Products |
| DI Water (optional) | 0.23 | n/a |

*resin weight may comprise up to about 50% CTBN polymer

TEPIC foam is processed in a manner similar to traditional rigid polyurethane foams. Each of the reactants is added sequentially, and hand stirred using a metal spatula. First, an epoxy resin (EPON® 826 manufactured by Resolution Performance Products, LLC) formed by a condensation reaction of bisphenol A (4,4′-isopropylidenediphenol) and epichlorohydrin (1-chloro-2,3-epoxypropane), is mixed together with a surfactant (DC193®), and water (when included) in a 4 liter container (for the quantities listed in Table 1). Epoxies that may be suitably substituted for EPON® 826 include those prepared with bisphenol F (4′,4′-methylenediphenol) rather than with bisphenol A. Moreover, carboxyl-terminated butadiene acrylonitrile (CTBN) polymer additives may be included in the epoxide resin as a toughening agent in amounts up to about 50 weight percent of the epoxide/CTBN polymer mixture.

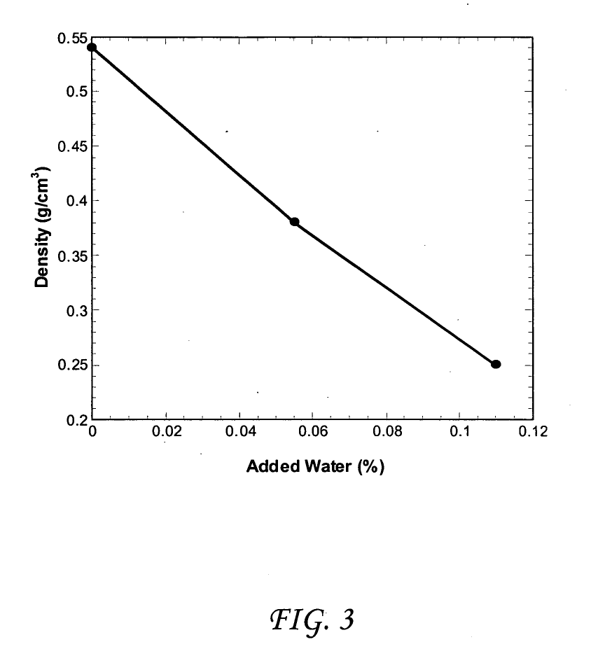

Once this initial mixing is completed, an isocyanate mixture comprising diphenylmethane diioscyanate, methylene bisphenyl isocyanate, and polymethylene polyphenyl isocyanate (PAPI® 94 manufactured by Dow Chemical Company) is stirred into the epoxide mixture, followed by a quantity of a light-weight, non-reactive bulk filler material such as hollow glass microspheres, sometimes referred to as “GMB” or glass microballoons®. Filler materials are added primarily as toughening agents and as viscosity modifiers to thicken the mixture and to control and uniformly distribute the formation of pores in the mixture as it reacts with water (as an impurity or intentionally added) to produce CO₂, The filler may be eliminated of course which results in a low viscosity precursor mixture that allows any CO₂ that is formed to quickly rise through the mixture and either escape or coalesce at the top of the mixture and yield a high density free-rise part. As seen in FIG. 3 small additional amounts of water, therefore, added directly into the pre-rise mixture can control the density of those TEPIC polymer parts in which a filler is added.

While the particular filler material used in the present formulation is a 3M® product identified by the trade name SCOTCHLITE® D32/4500, other material fillers/viscosity modifiers would be equally effective. Equivalent materials would include, but are not limited to, other classes of glass microsphere (Scotchlite® A15/500, K46, and S60/10,000) or MicroBalloons® (Shell Chemical); glass-ceramic cenospheres (coal combustion fly ash) such as are available from AshTek, or from Trelleborg Fillite Inc. (FILLITE®); multi-cellular glass microspheres available from Grefco Minerals, Inc. (Dicaperl); polymeric microspheres; Cab-O-Sil® (submicron “fumed” silicon dioxide particles manufactured by Cabot Industries); comminuted mica, or beta eucryptite, and the like, are also useful as non-reactive, bulk fillers. In addition, various “chopped” or loose man-made fibers such as glass fibers (s-glass, e-glass), carbon fiber, and aramid fibers such as KEVLAR® (poly(p-phenyleneterephtalamide), manufactured by E. I. duPont de Nemours and Company, Wilmington, Del.) and similar equivalent materials, may be added to the foregoing bulk fillers in amounts varying from 0.3 weight percent to about 5 weight percent.

Filler materials can be difficult to fully incorporate and disperse into liquid mixes. Satisfactory incorporation of the filler and the liquid reactants is achieved by thorough mixing with a 4-inch CONN® blade for 3 to 5 minutes. Periodically, the sides of the container were scraped with a spatula to help further disperse the filler.

Lastly, a small quantity of two catalysts: a tertiary amine such as 2,4,6-tris(dimethylaminomethyl)phenol (DABCO® TMR-30 manufactured by Air Products and Chemical, Inc.) and a cyclic amine such as N,N-dimethylcyclohexylamine (POLYCAT® 8 manufactured by Air Products and Chemical, Inc.), is added to the other liquid reactants and again mixed with the CONN® blade for about an additional 45 seconds.

This mixture is then poured into a mold that had been coated with a release agent or wax and the mixed liquid allowed to gel and rise at room temperature over the next hour. The mold is then cured in a forced-air oven at set at 65° C. overnight.

Because the foam requires strength above ambient temperatures, an additional curing step is used to increase the T_{g} (glass transition temperature) of the cured polymer. To this end, the foam is removed from the mold and heated with a gradual ramp to 200° C. over 28 hours. The foam is then held for 5 hours before slowly being cooled to room temperature.

The processing conditions described above and the formulation listed in Table 1 yields a foam having a free-rise density of about 0.4 g/cm³. It was found that the quantity of water used in the formulation had a dramatic effect on the density of the foam as is shown in FIG. 3. It was also found that the particular combination of catalysts used in this composition was instrumental in producing a workable product having the desired density, pore size and mechanical strength. A prior formulation using only the tertiary amine catalyst TMR-3 was found to react much too quickly when water was used. This formulation produced a foam that rose rapidly and then collapsed in upon itself. Many other isocyanate trimerization agents were investigated but none could be found that would yield both an acceptable product and exhibit acceptable processing characteristics. Moreover, with the exception of TMR-30 none of the other catalysts was stable in the presence of water. However, TMR-30 alone did not provide the desired uniform pore structure probably due to its rapid reaction time when water was present.

It was discovered, therefore, that when the cyclic amine POLYCAT® 8 was added to formulations prepared with TMR-30 the desired balance between the various polymerization reactions and the gas generation reaction was achieved. The result was a foam gel with a stable cell structure that also possessed forgiving enough processing characteristics to allow manual mixing and molding.

The processing steps used for making TEPIC foam parts are summarized and listed below. The steps comprise:

1.) Adding surfactant (and Dl water, if used) to epoxy resin—Hand stir;

2.) Adding isocyanate resin to the epoxy/surfactant mixture—Hand stir;

3.) Adding the bulk filler to the epoxy/surfactant/isocyanate mixture—Mixing thoroughly with a CONN® blade for at least 1 minute;

4.) Adding a requisite quantity of TMR-30® and POLYCAT® 8 to the epoxy/surfactant/isocyanate/filler mixture—Mixing for about an additional 45 seconds with a CONN® blade;

5.) Pouring the mixed liquid into a mold;

6.) Allowing the mixed liquid to remain undisturbed at ambient temperature for at least 1 hour in order to gel;

7.) Heating the mold and contents in a forced air oven set at 65° C.±5° C. for about 12 to 16 hours to cure the gelled liquid;

8.) Removing the mold from the oven and demolding the reacted foam part;

9.) Cleaning the surface of the foam part by thoroughly wiping it with acetone; and

10.) Post-curing the foam part to 200° C. with the following temperature profile:

returning the foam part to the 65° C. oven for 2 hours;

ramping the temperature of the oven up to 150° C. over 8 hours and hold at this temperature for an additional 5 hours;

ramping the temperature of the oven up to 180° C. over 8 hours and hold at this temperature for an additional 5 hours;

ramping the temperature of the oven up to 200° C. over 5 hours and hold at this temperature for an additional 5 hours; and

ramping the temperature of the oven down to 65° C. over 5 hours and hold at this temperature for an additional 1 hour.

The time interval between Steps 5 and 6 should be less than 2 minutes since the mix will start to gel in the mixing container if it is not transferred into the mold fast enough.

During the post-cure cycle, Step 10, the actual ramp rate will vary depending on the characteristic part dimension. Parts with thicker cross-sectional dimensions will require slower ramp rates in order to avoid charring. For example, the ramp rate called out in Step 10 was optimized for parts with maximum thicknesses of about 10 centimeters (about 4″), and while part cross sections greater than 10 cm are well within the scope of this invention, at some point the required ramp rates will be so slow as to render the process impractical. For example, a ramp to 200° C. over the course of 4 days was used for a 30 cm diameter by approximately 50 cm tall cylinder of TEPIC.

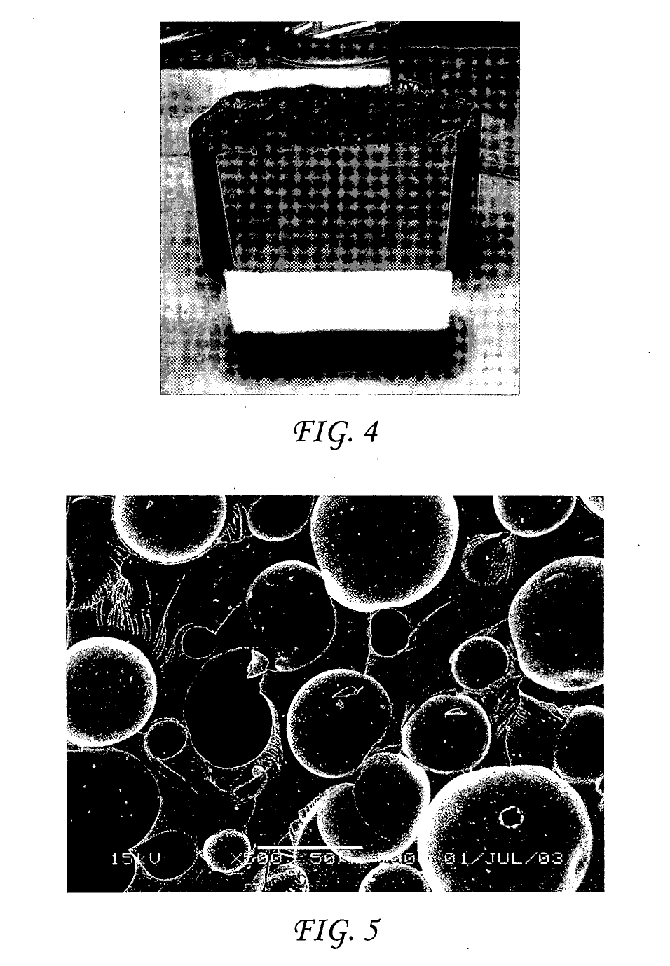

When prepared as described above, the resultant foam body exhibits an exterior “skin” having a caramel-brown appearance which extends inward less than a millimeter to reveal a core characterized as having an even distribution of fine pores (FIG. 4). This core region is further characterized as having a buff, cream colored appearance. An SEM photomicrograph of a typical fracture surface of the foam structure (FIG. 5) shows the polymer matrix strongly adhering to the GMB filler.

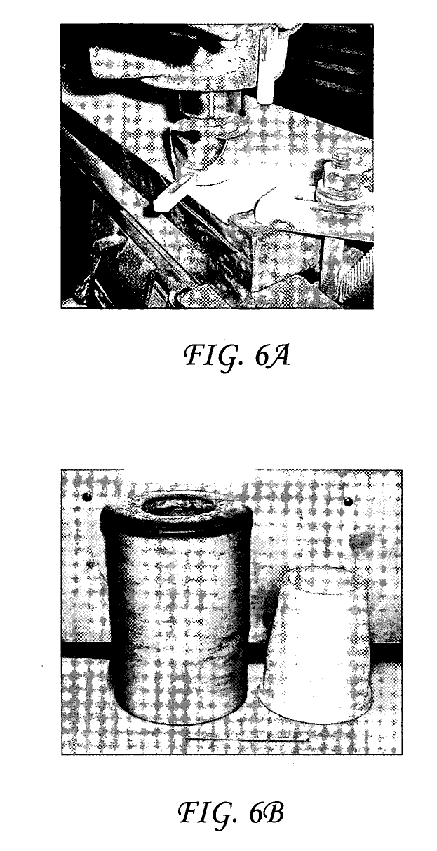

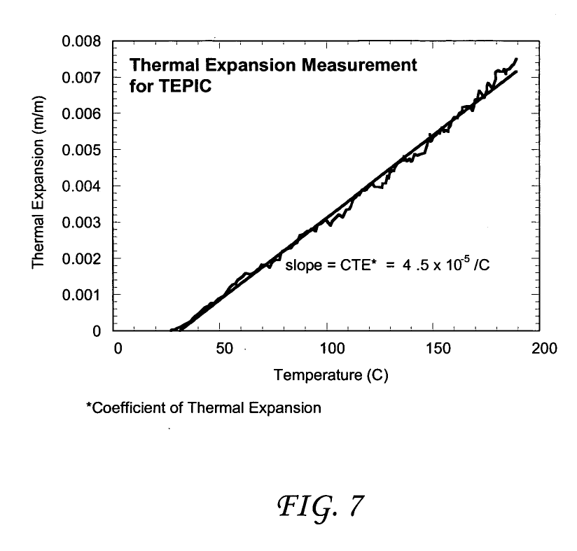

The material is also shown to machine cut easily and uniformly, much like phenolic. However, the TEPIC foam is abrasive because of the presence of the filler and machining is aided by the use of carbide or diamond tools to avoid excessive wear. FIG. 6A shows the surface of a sheet of the foam after it has been “planed” by fly-cutting with the tool that appears in the foreground. FIG. 6B shows a large cylinder of TEPIC before machining and a similar piece after being cut into the hollow, tapered cylinder shown. The finished polymer, therefore, is readily shaped either by direct molding or by milling or cutting the desired shape into the surfaces of a cast foam part. Furthermore, various coating products have been found to be effective in those situations where surface machining is called for but where a high gloss finish is necessary for a particular application. In particular, Dura Technologies Inc. Bloomington, Calif. manufactures polyester/styrene monomer primers (e.g. 702-003, 707-002, or 714-002) and coatings (602-021, 608-021, or 614-021) under the trade name Duratec®; and Dexter Aerospace, Pittsburg, Calif., (a division of the Henkel Loctite Corporation) manufactures a two-part amine cured epoxy resin (EA9396) under the trade name of Hysol®. These materials have been applied as a surface treatment on freshly milled TEPIC parts to provide a smooth, hard and void-free surface. Parts were treated in this way to aids in the release of parts prepared using the cured TEPIC as a mold.

### EXAMPLES

The following examples are provided as a way to better describe the present invention. Each includes the formulation used to prepare the polyisocyanurate foam body. Samples tested over a range of densities from 0.3 g/cm³ to about 0.8 grams/cm³ of about 0.4 g/cm³ were prepared. The present invention is not restricted to these densities alone, but was selected for convenience only in order to provide a baseline for comparison.

The general formulation for providing the low density polyisocyanurate foam of the present invention is shown above. Several variations of this general formula, however, have been found to be suitable. In particular, foam samples were produced using a variety of different filler materials and a variety of different epoxies (with and without an elastomeric additive) so as to determine the effect of changing the formulation on density and on compression strength, especially at elevated temperatures. The TEPIC formulations used to produce these test specimen are shown below in Tables 2A and 2B.

TABLE 2A
VARIOUS TEPIC FORMULATIONS
SINGLE EPOXY CONSTITUENT

| | SAMPLE ID | | | | | | |
|---|---|---|---|---|---|---|---|
| | 002 | 013 | 023 | 024a | 024c | 030 | 155 |
| | QTY | | | | | | |
| | MASS | MASS | MASS | MASS | MASS | MASS | MASS |
| CONSTITUENTS | (GRAMS) | (GRAMS) | (GRAMS) | (GRAMS) | (GRAMS) | (GRAMS) | (GRAMS) |
| PAPI 2094 | 488.70 | 243.59 | 243.22 | 250.43 | 121.52 | 255.00 | 485.90 |
| TMR-30 | 2.26 | 1.12 | 1.16 | 1.18 | 0.56 | 1.13 | 2.26 |
| Polycat 8 | 0.91 | 0.46 | 0.45 | 0.45 | 0.25 | 0.45 | 0.94 |
| DC 193 | 35.3 | 16.46 | 16.28 | 16.24 | 8.24 | 16.26 | 32.35 |
| SUBTOTAL CONSTITUENTS | 527.17 | 261.63 | 261.11 | 268.30 | 130.57 | 272.84 | |
| Epoxies | | | | | | | |
| EPON 826 | 267.21 | | 130.06 | 130.37 | 65.87 | 132.63 | 258.36 |
| EPON 8280 | | 130.98 | | | | | |
| EPON 826 + 10% CTBN | | | | | | | |
| EPON 58005 + 10% CTBN | | | | | | | |
| EPON 58006 + 10% CTBN | | | | | | | |
| EPON 58034 + 10% CTBN | | | | | | | |
| EPON 58042 + 10% CTBN | | | | | | | |
| SUBTOTAL EPOXY | 267.21 | 130.98 | 130.06 | 130.37 | 65.87 | 132.63 | 258.36 |
| TOTAL REACTANTS | 794.38 | 392.61 | 391.17 | 398.67 | 196.44 | 405.47 | |
| Fillers | | | | | | | |
| GMB A16/500 | | | 48.28 | | | | |
| GMB D32/4500 | | 48.3 | | | | | 96.00 |
| GMB K46 | | | | | | 48.85 | |
| Dicaperl HP 910 | | | | | 24.02 | | |
| Fillite 300LF | 96.41 | | | 62.65 | | | |

TABLE 2B
VARIOUS TEPIC FORMULATIONS
CTBN MODIFIED EPOXY CONSTITUENTS

| | SAMPLE ID | | | | | | |
|---|---|---|---|---|---|---|---|
| | 005 | 038 | 039 | 040 | 041 | 042 | 043 |
| | QTY | | | | | | |
| | MASS | MASS | MASS | MASS | MASS | MASS | MASS |
| CONSTITUENTS | (GRAMS) | (GRAMS) | (GRAMS) | (GRAMS) | (GRAMS) | (GRAMS) | (GRAMS) |
| PAPI 2094 | 486.03 | 124.84 | 121.78 | 121.70 | 121.89 | 121.51 | 121.57 |
| TMR-30 | 2.25 | 0.56 | 0.56 | 0.59 | 0.60 | 0.58 | 0.58 |
| Polycat 8 | 0.94 | 0.23 | 0.24 | 0.23 | 0.23 | 0.23 | 0.24 |
| DC 193 | 32.34 | 8.26 | 8.23 | 8.88 | 8.31 | 8.22 | 8.12 |
| SUBTOTAL CONSTITUENTS | 521.56 | 133.89 | 130.81 | 131.40 | 131.03 | 130.54 | 130.51 |
| EPOXIES | | | | | | | |
| EPON 826 | | 49.13 | 49.65 | 53.61 | 51.82 | | |
| EPON 8280 | | | | | | | |
| EPON 826 + 10% CTBN | 259.07 | | | | | | |
| EPON 58005 + 10% CTBN | | | 16.34 | | | | |
| EPON 58006 + 10% CTBN | | 16.34 | | | | 65.05 | |
| EPON 58034 + 10% CTBN | | | | 12.98 | | | 64.91 |
| EPON 58042 + 10% CTBN | | | | | 13.00 | | |
| SUBTOTAL EPOXY | 259.07 | 65.47 | 65.99 | 66.59 | 64.82 | 65.05 | 64.91 |
| TOTAL REACTANTS | 780.63 | 199.36 | 196.80 | 197.99 | 195.85 | 195.59 | 195.42 |
| FILLERS | | | | | | | |
| GMB A16/500 | | | | | | | |
| GMB D32/4500 | 96.06 | 24.01 | 24.10 | 24.04 | 24.01 | 24.00 | 24.04 |
| GMB K46 | | | | | | | |
| Dicaperl HP 910 | | | | | | | |
| Fillite 300LF | | | | | | | |

Mechanical test samples were prepared by coring 2 cm diameter cylinders from centers of molded, free-rise blocks of the foam. These cylinders were then cut to 3 cm lengths and the ends sanded flat and parallel to a final height of 2.5 cm. These test samples were then tested to failure under compressive loading at both room temperature and at about 200° C.

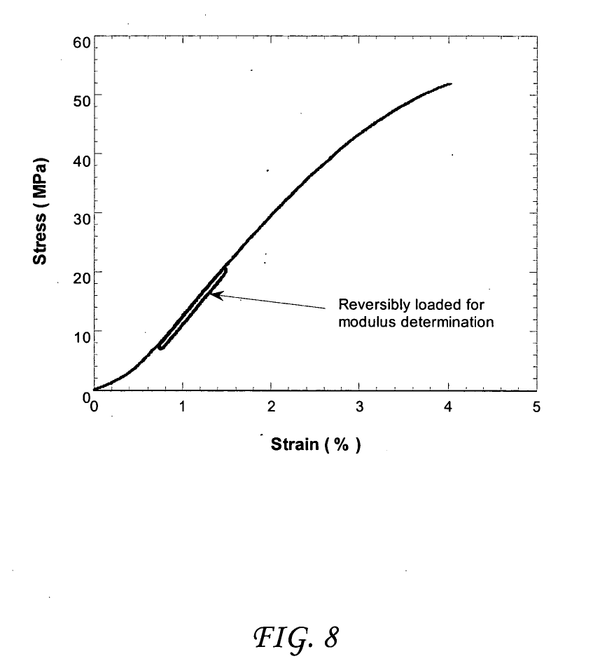

FIGS. 7 and 8 are exemplary of the test response of a typical TEPIC body produced with a glass microsphere bulk filler. In particular, FIG. 7 shows the thermal expansion response of a specimen prepared from sample formulation #155 heated between room temperature and about 200° C. The calculated coefficient of thermal expansion (“CTE”) for this sample was found to fall near the low end of the range of thermal expansion coefficients for most polyurethane foams (known to range from about 5 to about 10×10⁻⁵° C.⁻¹). It also was found that the CTE of the sample could be adjusted by manipulating the content and quantity of the bulk filler used. Applicants have produced a beta-eucryptite loaded TEPIC foam having a CTE of 2.8×10⁻⁵° C.⁻¹ in the temperature range of 25° C. to 125° C., a value closely comparable to that of aluminum (2.5×10⁻⁵° C.⁻¹).

FIG. 8 shows both the strain response of this same material when subjected to compression loading while heated at 200° C. The figure also shows the region over which the sample modulus was determined.

The data generated by the aforementioned mechanical tests is summarized below in Tables 3 and 4. As is clearly evident, the high temperature compression tests maintain significant strength showing only about a 30% to a less then a 50% fall-off in total compression strength at elevated temperatures relative to tests performed at room temperature. The polyisocyanurate foam of the present invention therefore, is seen to remain strong at elevated temperatures and pressures making the material suitable for a variety of useful purposes including, but not limited to composite “lay-up” tools, injection mold tools or inserts, inserts for forming mold cavities for metal castings, inserts for hot embossing, and the like.

TABLE 3
RESPONSE OF TEPIC SPECIMENS TESTED TO
FAILURE UNDER A COMPRESSIVE LOAD AT
ROOM TEMPERATURE.

| | | FRACTURE | |
|---|---|---|---|
| | DENSITY | STRESS | MODULUS |
| SAMPLE No. | (g/cm³) | (MPa) | (GPa) |
| 005 | 0.66 | 55.7 | 1.8 |
| 022 | 0.83 | 66.0 | 2.4 |
| 023 | 0.46 | 26.8 | 1.3 |
| 024B | 0.48 | 19.2 | 1.0 |
| 025 | 0.82 | 67.1 | 2.4 |
| 038 | 0.58 | 38.2 | 1.4 |
| 039 | 0.55 | 33.5 | 1.3 |
| 041 | 0.59 | 40.4 | 1.6 |
| 042 | 0.58 | 26.3 | 0.8 |
| 155 | 0.63 | 50.8 | 1.7 |

TABLE 4
RESPONSE OF TEPIC TEST SPECIMENS TESTED
TO FAILURE UNDER COMPRESSIVE LOADS AT
200° C.

| | | FRACTURE | STRENGTH LOSS |
|---|---|---|---|
| | | STRESS AT | (RELATIVE TO ROOM |
| SAMPLE | DENSITY | 200° C. | TEMPERATURE RESPONSE) |
| NO. | (g/cm³) | (MPa) | (%) |
| 005 | 0.66 | 29.8 | 46 |
| 022 | 0.83 | 39.5 | 40 |
| 023 | 0.46 | 15.1 | 44 |
| 039 | 0.55 | 23.6 | 30 |
| 041 | 0.59 | 26.9 | 33 |
| 042 | 0.58 | 18.2 | 31 |
| 155 | 0.63 | 34.1 | 33 |

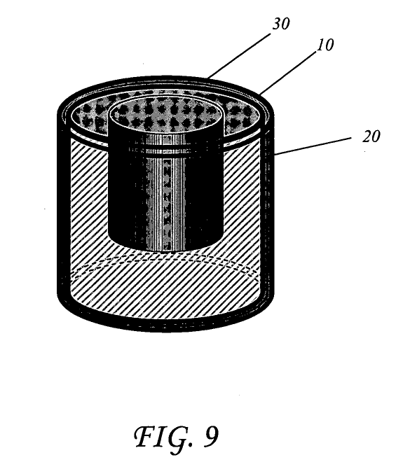

Moreover, the composition also lends itself to methods for controlling the weight and/or the mechanical strength by forming parts as hollow shells, by casting the TEPIC foam 10 in a mold 20 wherein most of the interior volume is occupied by a mold insert 30 (see FIG. 9). Furthermore, the range of working viscosities available with the composition allows a user to “spray-coat” or over-lay the pre-rise liquid onto large areas/surfaces (over a coated rough-cut polystyrene mold, for instance) and to then machine the final exterior surface shape into the overcast layer.

Lastly, in those TEPIC formulations which incorporate a GMB filler, the materials also act as an effective insulator that may be applied directly, again by “spray-coating”, or as cast, or a shaped “board”.

Therefore, while the particular formulations devices as described herein are fully capable of attaining the objects of the invention, it is to be understood that 1) the formulations and devices are the presently preferred embodiments of the present invention and are thus representative of the subject matter which is broadly contemplated by the present invention; 2) the scope of the present invention is intended to encompass those other embodiments which may become obvious to those skilled in the art; and 3) the scope of the present invention is accordingly to be limited by nothing other than the appended claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”. Lastly, all material quantities and amounts are in parts by weight or by weight percentages, unless otherwise indicated.

What is claimed is:

1. A light-weight polyisocyanurate foam composition, comprising:
a) an epoxide resin;
b) an isocyanate resin;
c) a tertiary amine catalyst;
d) a cyclic amine.

2. The light-weight polyisocyanurate foam composition of claim 1, wherein the isocyanate resin comprises a mixture of diphenylmethane diioscyanate, methylene bisphenyl isocyanate, and polymethylene polyphenyl isocyanate.

3. The light-weight polyisocyanurate foam composition of claim 1, wherein the epoxide resin is a mixture of either bisphenol A and epichlorohydrin or bisphenol F and epichlorohydrin.

4. The light-weight polyisocyanurate foam composition of claim 3, wherein the quantity of epoxide resin further comprises up to about 50 weight percent of a carboxyl-terminated butadiene acrylonitrile polymer.

5. The light-weight polyisocyanurate foam composition of claim 1, wherein the tertiary amine is 2,4,6-tris(dimethylaminomethyl)phenol.

6. The light-weight polyisocyanurate foam composition of claim 5, wherein the cyclic amine is N,N-dimethylcyclohexylamine.

7. The light-weight polyisocyanurate foam composition of claim 1, wherein said tertiary amine and said cyclic amine are present in a ratio amount equal to about 2:1 to about 2.8:1 of tertiary-to-cyclic amine and wherein the total quantity of amine is present in an amount equal to about 0.5% to about 0.7% of said isocyanate resin.

8. The light-weight polyisocyanurate foam composition of claim 1, wherein the epoxide resin is present in an amount of about 51% to about 56% of said isocyanate resin.

9. The light-weight polyisocyanurate foam composition of claim 1, wherein said epoxide resin and said isocyanate resin are present in a ratio amount of about 1:1.8 to about 1:2 of epoxide resin to isocyanate resin.

10. The light-weight polyisocyanurate foam composition of claim 1, wherein the isocyanate resin is present in an amount of about 60 weight percent to about 65 weight percent of said epoxide resin, said isocyanate resin, and said tertiary and cyclic amines.

11. The light-weight polyisocyanurate foam composition of claim 1, further comprises a bulk filler.

12. The light-weight polyisocyanurate foam composition of claim 11, wherein the bulk filler is present in an amount of about 10 weight percent to about 15 weight percent of said epoxide resin, said isocyanate resin, and said tertiary and cyclic amines.

13. The light-weight polyisocyanurate foam composition of claim 12, wherein the bulk filler is selected from the list consisting of glass microspheres, glass-ceramic cenospheres, multi-cellular glass microspheres, polymeric microspheres, and comminuted form of silicon dioxide, mica, and beta eucryptite, and combinations thereof.

14. The light-weight polyisocyanurate foam composition of claim 13, wherein the bulk filler further comprises fibers selected from the list consisting of fibers such as carbon fibers, e-glass, s-glass, and aramid fibers, and combinations thereof.

15. The light-weight polyisocyanurate foam composition of claim 1, further including a surface active agent.

16. The light-weight polyisocyanurate foam composition of claim 15, wherein the surface active agent is present in an amount of about 2 weight percent to about 5 weight percent of said epoxide resin, said isocyanate resin, and said tertiary and cyclic amines.

17. The light-weight polyisocyanurate foam composition of claim 1, further comprising a quantity of water.

18. The light-weight polyisocyanurate foam composition of claim 17, wherein the water is present in amounts of about 0.05 weight percent to about 0.12 weight percent of said epoxide resin, said isocyanate resin, and said tertiary and cyclic amines.

19. A process for making a high temperature-resistant closed cell polyisocyanurate foam, comprising the steps of:
a) combining a quantity of an epoxide resin and a quantity of an isocyanate resin to provide a mixed resin mixture;
b) adding a quantity of a tertiary amine and a quantity of a cyclic amine to resin mixture;
c) mixing said resin mixture and said tertiary amine and said cyclic amine to provide a pre-expanded foam gel;
d) dispensing said pre-expanded foam gel into a mold and allowing said gel to react and expand into a closed cell foam;
e). heating said mold and said expanded foam to about 65° C. for about 12 hours to about 16 hours to provide a cured foam member;
f) cooling said mold and said cured foam member to room temperature;
g) removing said cured foam member from said mold; and
h) post-curing said cured foam member by re-heating said cured foam member step-wise to a temperature of about 200° C.

20. The process of claim 19, wherein said isocyanate resin comprises a mixture of diphenylmethane diioscyanate, methylene bisphenyl isocyanate, and polymethylene polyphenyl isocyanate.

21. The process of claim 19, wherein said epoxide resin comprises a mixture of either bisphenol A/epichlorohydrin or bisphenol F and epichlorohydrin.

22. The process of claim 21, wherein the quantity of epoxide resin further comprises up to about 50 weight percent of a carboxyl-terminated butadiene acrylonitrile polymer.

23. The process of claim 19, wherein the tertiary amine is 2,4,6-tris(dimethylaminomethyl)phenol.

24. The process of claim 23, wherein the cyclic amine is N,N-dimethylcyclohexylamine.

25. The process of claim 19, wherein said quantities of said tertiary amine and said cyclic amine are in a ratio amount equal to about 2:1 to about 2.8:1 of tertiary to cyclic amine, and wherein the total quantity of amine is equal to about 0.5% to about 0.7% of said quantity of said isocyanate resin.

26. The process of claim 19, wherein the quantity of epoxide resin is about 51% to about 56% of said quantity of isocyanate resin.

27. The process of claim 21, wherein said epoxide resin and said isocyanate resin are present in a ratio amount of about 1:1.8 to about 1:2 of epoxide resin to isocyanate resin.

28. The process of claim 19, wherein the isocyanate resin is present in an amount of about 60 weight percent to about 65 weight percent of said epoxide resin, said isocyanate resin, and said tertiary and cyclic amines

29. The process of claim 19, wherein the step of combining further comprises the steps of adding a quantity of a bulk filler to said mixed resin mixture, and incorporating said resin mixture and said bulk filler for about 1 minute.

30. The process of claim 29, wherein the bulk filler is present in an amount of about 10 weight percent to about 15 weight percent of said epoxide resin, said isocyanate resin, and said tertiary and cyclic amines.

31. The process of claim 30, wherein the bulk filler is selected from the list consisting of glass microspheres, glass-ceramic cenospheres, multi-cellular glass microspheres, polymeric microspheres, and comminuted form of silicon dioxide, mica, and beta eucryptite, and combinations thereof.

32. The process of claim 31, wherein the bulk filler further comprises fibers selected from the list consisting of fibers such as carbon fibers, e-glass, s-glass, and aramid fibers, and combinations thereof.

33. The process of claim 19, wherein said step of combining said epoxide resin and said isocyanate resin further includes adding a quantity of a surface active agent.

34. The process of claim 33, wherein the surface active agent is present in an amount of about 2 weight percent to about 5 weight percent of said epoxide resin, said isocyanate resin, and said tertiary and cyclic amines.

35. The process of claim 19, wherein the step of mixing said resin mixture and said tertiary and cyclic amines further comprises the step of adding a quantity of water.

36. The process of claim 35, wherein the water is present in amounts of about 0.05 weight percent to about 0.12 weight percent of said epoxide resin, said isocyanate resin, and said tertiary and cyclic amines.

37. The process of claim 19, wherein the step of post-curing further comprises the step of increasing the temperature of said cured foam member to 200° C. over a period of at least about 36 hours.

38. The process of claim 37, wherein the step of increasing said temperature further comprises the steps of:
a) heating the cured foam member to the 65° C. for about 2 hours;
b) increasing the temperature of the cured foam member up to 150° C. over about 8 hours and holding the temperature of the cured foam member at about to 150° C. for an additional 5 hour;
c) increasing the temperature of the cured foam member to about 180° C. over about 8 hours and holding the temperature of the cured foam member at about to 180° C. for an additional 5 hours;
d) increasing the temperature of the cured foam member to about 200° C. over about 5 hours and holding the temperature of the cured foam member at about to 200° C. for an additional 5 hour;
e) deceasing the temperature of the cured foam member about to 65° C. over about 5 hours and holding the temperature of the cured foam member at about to 65° C. for an additional 1 hour; and
f) cooling the temperature of the cured foam member to room temperature.

39. A tool made by a process comprising the steps of:
a) combining an epoxide resin and an isocyanate resin to provide a resin mixture;
b) adding a mixture of an tertiary amine and a cyclic amine to said resin mixture, said amine initiating a reaction between said epoxide resin and said isocyanate resin to form a polymer gel;
c) dispensing said polymer gel into a mold;
d) curing the polymer gel at a temperature of about 65° C. to provide a polyisocyanurate foam member;
e) cooling said mold and de-molding said polyisocyanurate foam member;
f) post-curing the polyisocyanurate foam member by re-heating the polyisocyanurate foam member step-wise to a temperature of about 200° C.;
g) cooling said post-cured polyisocyanurate foam member to room temperature to provide a post-cured polyisocyanurate foam tool, said post-cured foam tool sustaining prolonged exposure to temperatures up to about 200° C. while also maintaining a mechanical compressive strength of at least 25 MPa.

40. The tool of claim 39, wherein said isocyanate resin comprises a mixture of diphenylmethane diioscyanate, methylene bisphenyl isocyanate, and polymethylene polyphenyl isocyanate.

41. The tool of claim 39, wherein said epoxide resin comprising a mixture of bisphenol A and epichlorohydrin resins or a mixture of bisphenol F and epichlorohydrin resins.

42. The tool of claim 41, wherein the quantity of epoxide resin further comprises up to about 50 weight percent of a carboxyl-terminated butadiene acrylonitrile polymer.

43. The tool of claim 39, wherein the tertiary amine is 2,4,6-tris(dimethylaminomethyl)phenol.

44. The tool of claim 43, wherein the cyclic amine is N,N-dimethylcyclohexylamine.

45. The tool of claim 39, wherein said quantities of said tertiary amine and said cyclic amine are in a ratio amount equal to about 2:1 to about 2.8:1 of tertiary to cyclic amine, and wherein the total quantity of amine is equal to about 0.5% to about 0.7% of said quantity of said isocyanate resin.

46. The tool of claim 39, wherein the quantity of epoxide resin is about 51% to about 56% of said quantity of isocyanate resin.

47. The tool of claim 39, wherein said epoxide resin and said isocyanate resin are present in a ratio amount of about 1:1.8 to about 1:2 of epoxide resin to isocyanate resin.

48. The tool of claim 39, wherein the isocyanate resin is present in an amount of about 60 weight percent to about 65 weight percent of said epoxide resin, said isocyanate resin, and said tertiary and cyclic amines.

49. The tool of claim 39, wherein said step of combining said epoxide resin and said isocyanate resin further includes adding a quantity of a surface active agent.

50. The tool of claim 49, wherein the surface active agent is present in an amount of about 2 weight percent to about 5 weight percent of said epoxide resin, said isocyanate resin, and said tertiary and cyclic amines.

51. The tool of claim 39, wherein the step of combining further comprises the steps of adding a quantity of a bulk filler to said mixed resin mixture, and incorporating said resin mixture and said bulk filler for about 1 minute.

52. The tool of claim 51, wherein the bulk filler is present in an amount of about 10 weight percent to about 15 weight percent of said epoxide resin, said isocyanate resin, and said tertiary and cyclic amines.

53. The tool of claim 52, wherein the bulk filler is selected from the list consisting of glass microspheres, glass-ceramic cenospheres, multi-cellular glass microspheres, polymeric microspheres, and comminuted form of silicon dioxide, mica, and beta eucryptite, and combinations thereof.

54. The tool of claim 53, wherein the bulk filler further comprises fibers selected from the list consisting of fibers such as carbon fibers, e-glass, s-glass, and aramid fibers, and combinations thereof.

55. The tool of claim 51, wherein the bulk filler is present in an amount of about 10 weight percent to about 15 weight percent of said epoxide resin, said isocyanate resin, and said tertiary and cyclic amines.

56. The tool of claim 39, wherein said step of combining said epoxide resin and said isocyanate resin further includes adding a quantity of water.

57. The tool of claim 39, wherein the step of post-curing further comprises the step of increasing the temperature of said cured foam member to 200° C. over a period of at least about 36 hours.

58. The tool of claim 57, wherein the step of increasing said temperature further comprises the steps of:
a) heating the cured foam member to the 65° C. for about 2 hours;
b) increasing the temperature of the cured foam member up to 150° C. over about 8 hours and holding the temperature of the cured foam member at about to 150° C. for an additional 5 hours;
c) increasing the temperature of the cured foam member to about 180° C. over about 8 hours and holding the temperature of the cured foam member at about to 180° C. for an additional 5 hours;
d) increasing the temperature of the cured foam member to about 200° C. over about 5 hours and holding the temperature of the cured foam member at about to 200° C. for an additional 5 hours;
e) deceasing the temperature of the cured foam member about to 65° C. over about 5 hours and holding the temperature of the cured foam member at about to 65° C. for an additional 1 hour; and
f) cooling the temperature of the cured foam member to room temperature.

59. The tool of claim 58, further including the step of milling or shaping one or more surfaces to provide a 3-dimensional tool contour.

60. The tool of claim 59, further including coating the 3-dimensional tool contour with a polymer conformal coating.

61. The tool of claim 59, further comprising a positive or negative relief image on a surface and wherein said tool is adapted for use as a hot embossing tool master.

62. The tool of claim 59, further comprising one or more contiguous inserts forming a positive or negative 3-dimensional image, and wherein said one or more contiguous inserts are adapted for use as an injection mold die tool.

63. A large tool assembly comprising the step of gluing or bonding together two or more individual tools prepared by the process of claim 59.

64. A tool made by a process comprising the steps of:
a) combining an epoxide resin and an isocyanate resin to provide a resin mixture;
b) adding a mixture of an tertiary amine and a cyclic amine to said resin mixture, said amine initiating a reaction between said epoxide resin and said isocyanate resin to form a polymer gel;
c) applying said polymer gel onto a surface;
d) curing the polymer gel at a temperature of about 65° C. to provide a polyisocyanurate foam layer;
e) cooling said polyisocyanurate foam layer;
f) post-curing the polyisocyanurate foam layer by re-heating the polyisocyanurate foam member step-wise to a temperature of about 200° C.;
g) cooling said post-cured polyisocyanurate foam layer to room temperature, to provide a foam tool for sustaining prolonged exposure to temperatures up to about 200° C. while also maintaining a mechanical compressive strength of at least 25 MPa.

65. The tool of claim 64, wherein the step of applying further comprises spraying said foam gel onto said surface.

66. A high temperature insulation medium comprising the composition of claim 12.

67. A high temperature insulation medium made by the process of claim 30.
